(19) United States
(12) Patent Application Publication
(10) Pub. No.: US 2012/0327169 A1
(43) Pub. Date: Dec. 27, 2012

(54) EXPOSURE APPARATUS, ADJUSTMENT METHOD THEREFOR, AND IMAGE FORMING APPARATUS

(75) Inventor: Hiroki Sato, Toride-shi (JP)

(73) Assignee: CANON KABUSHIKI KAISHA, Tokyo (JP)

(21) Appl. No.: 13/491,350

(22) Filed: Jun. 7, 2012

(30) Foreign Application Priority Data
Jun. 21, 2011 (JP) 2011-137738

(51) Int. Cl. B41J 2/435

(52) U.S. Cl. 347/224

(57) ABSTRACT

An exposure apparatus of the present invention, including a plurality of laser light sources (LDs), obtains reference data used for limiting a driving current within an allowable range at the time of APC with respect to each LD. The reference data on the first laser light source (LD1) is stored in advance in a memory at the time of factory shipment. The exposure apparatus determines, as the reference data of each of the LDs other than the LD1, the driving current supplied to each LD such that the light power of each LD is equal to that of the LD1 when being caused to emit light based on the reference data on the LD1 stored in the memory, thereby easily obtaining the reference data necessary for APC.

### BACKGROUND OF THE INVENTION

1. Field of the Invention

The present invention relates to an exposure apparatus, an adjustment method therefor, and an image forming apparatus using the exposure apparatus.

2. Description of the Related Art

Generally, in the exposure apparatuses such as optical scanning apparatuses used in electrographic image forming apparatuses, automatic power control (APC) is performed to keep a constant light power of a laser diode (LD) used as a laser light source during image forming. For example, Japanese Patent Laid-Open No. 63-163872 proposes a multi-beam image forming apparatus having a plurality of laser light sources in order to expose photosensitive member by scanning a plurality of optical beams (laser beams) over a photosensitive member. In such an image forming apparatus, with the smaller number of sensors than the optical beams output by the plurality of laser light sources, the light power of all optical beams is detected by detecting the light power of each optical beam in a time-sharing manner, and performs automatic power control individually with respect to each laser light source.

Meanwhile, Japanese Patent Laid-Open No. 09-230259 proposes a technique of individually adjusting the light power of an optical beam from each light emitting point using APC in an optical scanning device in which a plurality of optical beams output from a laser light source having a plurality of light emitting points are scanned over a photosensitive member. In the optical scanning device proposed in Japanese Patent Laid-Open No. 09-230259, a single light receiving sensor detects an optical beam to perform synchronization processing at the time of scanning the optical beams over the photosensitive member, and also monitors the light power of the optical beam used in the APC with respect to each of the optical beams output from the plurality of light emitting points.

An LD included in an exposure apparatus outputs an optical beam of a light power corresponding to a driving current supplied from a current source. As mentioned above, with the APC performed in an exposure apparatus, the light power of an optical beam emitted by the LD is controlled by controlling the driving current supplied from the current source to the LD. Since LDs are generally prone to breakage due to overcurrent, it is necessary, when controlling the driving current supplied to LDs, to control the current value within an appropriate range to avoid an excessively high current.

To control the driving current for an LD within an appropriate range when controlling the light power of the LD with APC, reference data used to limit the driving current within an allowable range is necessary. This reference data is, for example, a limit value (a maximum value equivalent to the 100% light power) of the driving current to be supplied to the LD, which is obtained by measuring in advance the characteristics of the LD when the LD is incorporated in the exposure apparatus at the time of factory shipment. Further, if a plurality of LDs are incorporated in an exposure apparatus and this exposure apparatus is operated as a multi-beam system, it is necessary to obtain the reference data individually with respect to each of the plurality of LDs at the time of factory shipment.

As described above, it is necessary to obtain the reference data used when performing APC with prior individual measurement with respect to each LD (laser light source) incorporated in an exposure apparatus and store the obtained data in a storage device at the time of factory shipment. However, as the number of LDs for which measurement needs to be performed increases with adoption of the multi-beam system of the exposure apparatuses, the man-hour in an apparatus assembly process at the time of factory shipment increases, and the time taken to measure the characteristics of each LD also increases. Accordingly, there is a problem of lower productivity during assembling apparatuses at the time of factory shipment.

### SUMMARY OF THE INVENTION

The present invention was made in light of the foregoing problem, and provides a technique of more easily obtaining reference data necessary for performing APC with respect to each laser light source in a multi-beam exposure apparatus.

According to one aspect of the present invention, there is provided an exposure apparatus having a plurality of laser light sources for outputting an optical beam due to a drive current supplied from a current source, comprising: a storage unit configured to store reference data used for limiting a driving current to be supplied to a first laser light source among the plurality of laser light sources within an allowable range when a light power of the first laser light source is controlled at a predetermined light power by controlling the driving current; a determination unit configured to determine a driving current supplied to a second laser light source other than the first laser light source among the plurality of laser light sources such that the light power of the second laser light source is equal to the light power of the first laser light source when being caused to emit light based on the reference data stored in the storage unit; and a storing unit configured to store, in the storage unit, a value of the driving current determined by the determination unit as the reference data used when the driving current supplied to the second laser light source is controlled.

According to another aspect of the present invention, there is provided an adjustment method for an exposure apparatus including a plurality of laser light sources each outputting an optical beam due to a driving current supplied from a current source, and a storage unit that configured to store reference data used for limiting a driving current to be supplied to a first laser light source among the plurality of laser light sources within an allowable range when a light power of the first laser light source is controlled at a predetermined light power by controlling the driving current, the adjustment method comprising: determining a driving current supplied to a second laser light source other than the first laser light source among the plurality of laser light sources such that the light power of the second laser light source is equal to the light power of the first laser light source when being caused to emit light based on the reference data stored in the storage unit; and storing, in the storage unit, a value of the driving current determined in the determining as the reference data used when the driving current supplied to the second laser light source is controlled.

According to the present invention, a technique of more easily obtaining reference data necessary for performing APC with respect to each laser light source in a multi-beam exposure apparatus can be provided. As a result thereof, it is possible at the time of factory shipment to prevent increase in man-hours in an apparatus assembly process in connection with adoption of the multi-beam system.

Further features of the present invention will become apparent from the following description of exemplary embodiments (with reference to the attached drawings).

### BRIEF DESCRIPTION OF THE DRAWINGS

FIG. 1 is a schematic cross-sectional view of an image forming apparatus 100 in an embodiment of the present invention.

FIG. 2 is a diagram showing a configuration of an optical scanning device 101 in an embodiment of the present invention.

FIG. 3 is an enlarged view of a laser chip 203 in an embodiment of the present invention.

FIG. 4 is a block diagram showing a configuration associated with obtaining of reference data based on control by a light power control unit 207 in an embodiment of the present invention.

FIG. 5 is a flowchart showing an entire flow of processing for obtaining the reference data in an embodiment of the present invention.

FIG. 6 is a flowchart showing a flow of processing for obtaining the reference data with respect to an LD other than a representative LD in an embodiment of the present invention.

FIG. 7 is a diagram showing change in data in a memory 208 during processing for obtaining the reference data in an embodiment of the present invention.

FIG. 8 is a diagram showing an example of another arrangement of a sensor (light-receiving unit) for detecting an optical beam in a configuration of the optical scanning device 101 in an embodiment of the present invention.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Configuration of the Image Forming Apparatus 100>

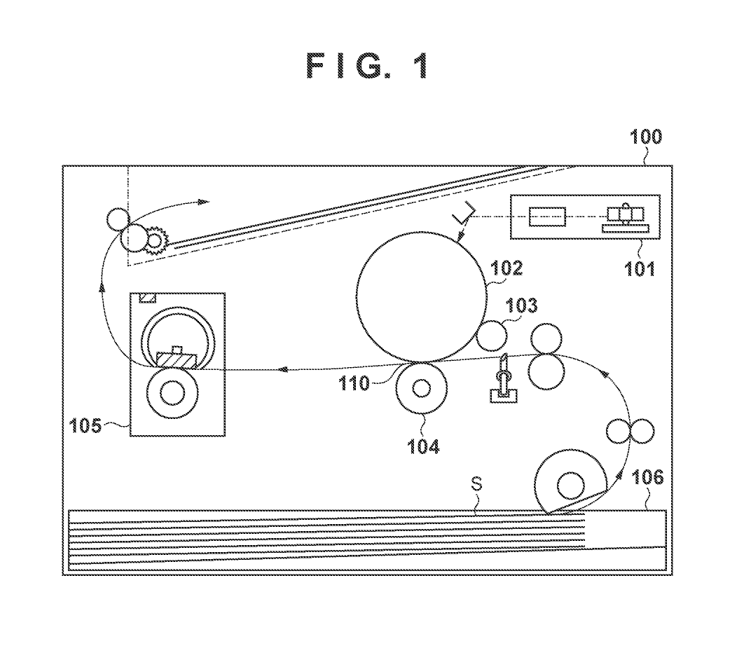

First, a configuration and operation of an image forming apparatus 100 in an embodiment of the present invention are described with reference to FIG. 1. The image forming apparatus 100 is, for example, a copying machine, a printer (printing apparatus), a facsimile apparatus, or a multi-function peripheral (MFP), and has a function to form an image on a surface of a recording material in accordance with input image information. The image forming apparatus 100 has an optical scanning device 101, which serves as an example of exposure apparatuses. The optical scanning device 101 includes a plurality of laser diodes (LD) that function as a plurality of laser light sources, and exposes a photosensitive drum 102 by scanning a plurality of optical beams (laser beams) output by the plurality of LDs over a surface of the photosensitive drum 102 that is an exposure target. Here, the photosensitive drum 102 serves an example of an image carrier. At the time of image formation, a charger (not shown) charges in advance the surface of the photosensitive drum 102 before exposure with a plurality of optical beams is performed.

Each LD included in the optical scanning device 101 outputs an optical beam in accordance with a driving current supplied from a current source. This driving current is modulated based on image information that indicates an image to be formed on a recording material. The optical scanning device 101 exposes the surface of the photosensitive drum 102 with a plurality of optical beams in accordance with the image information by supplying a driving current in accordance with the image information to each LD. As a result, an electrostatic latent image corresponding to an image to be formed on a recording material is formed on the surface of the photosensitive drum 102.

After that, with the rotation of the photosensitive drum 102, the electrostatic latent image formed on the surface thereof is conveyed to a nip portion between a developing unit 103 (e.g., a developing roller) and the photosensitive drum 102. The developing unit 103 develops the electrostatic latent image in the nip portion by causing a developing material (e.g., toner) to adhere to the electrostatic latent image on the surface of the photosensitive drum 102. Thus, an image to be transferred on a recording material is formed on the surface of the photosensitive drum 102. The developed image (developing material image) is then conveyed to a transfer nip portion 110 between a transfer device 104 (e.g., transfer roller) and the photosensitive drum 102 with the rotation of the photosensitive drum 102.

Meanwhile, a recording material S is fed from a recording material tray 106 and is conveyed along a conveyance path in accordance with a time when the image formed on the surface of the photosensitive drum 102 arrives at the transfer nip portion 110. In the transfer nip portion 110, the image on the photosensitive drum 102 is transferred to a surface of the recording material S due to the action of a prescribed voltage applied by the transfer device 104. The recording material S to which the image is transferred in the transfer nip portion 110 is then conveyed to a fixing device 105. The fixing device 105 fixes the image on the surface of the recording material S by applying heat and pressure to the conveyed recording material S. After being subjected to the fixing process performed by the fixing device 105, the recording material S is discharged outside the image forming apparatus 100.

<Configuration of the Optical Scanning Device 101>

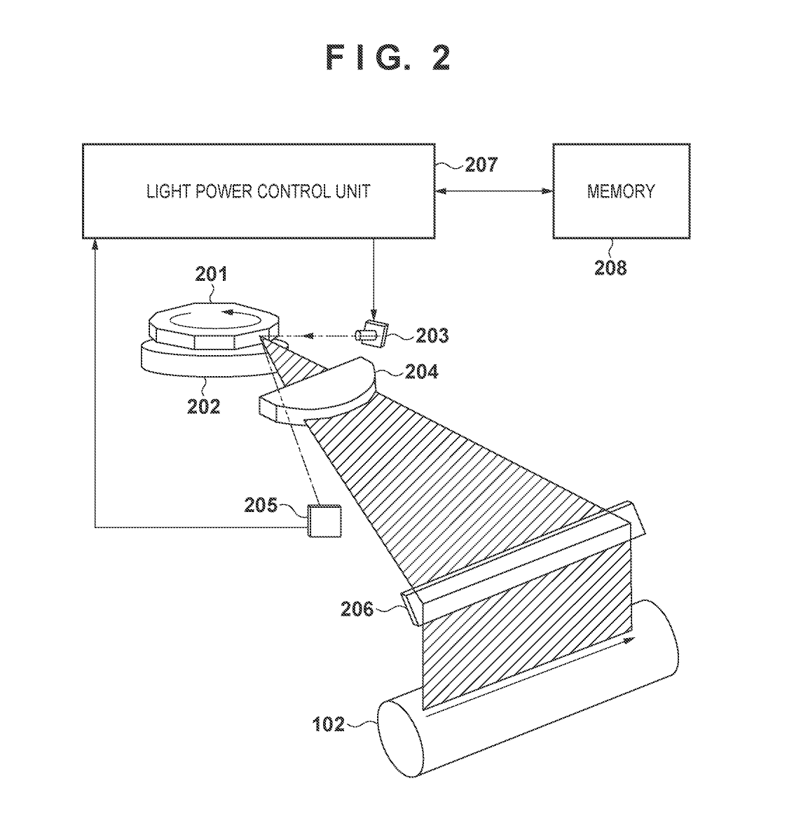

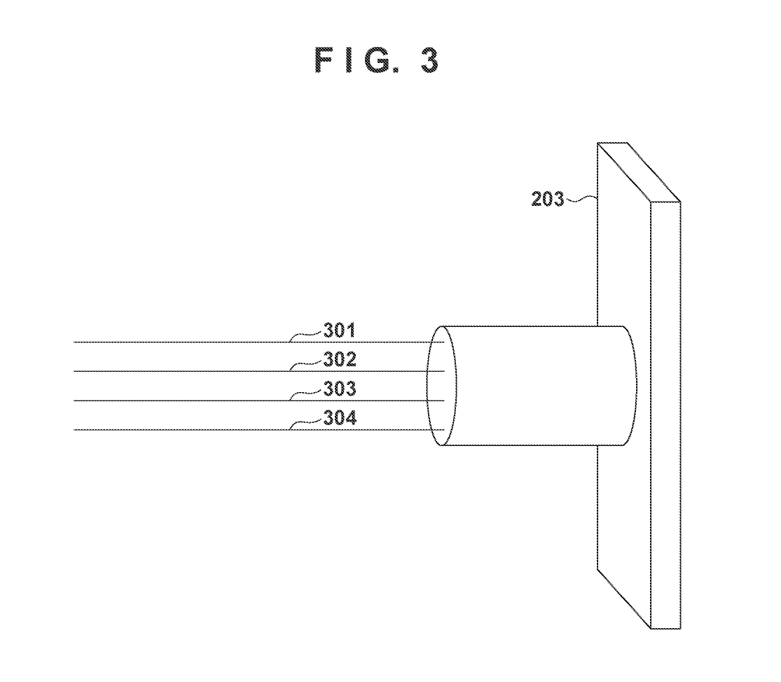

Next, a schematic configuration of the optical scanning device 101 is described with reference to FIGS. 2 and 3. In this embodiment, the optical scanning device 101 includes a polygon mirror 201, a polygon motor 202, a laser chip 203, an f-θ lens 204, a BD sensor 205, and a reflection mirror 206. The optical scanning device 101 also includes a light power control unit 207 for controlling operation of each of those components and a memory 208 in which various data used by the light power control unit 207 is stored. The laser chip 203 has a plurality of laser diodes (LDs) that are semiconductor lasers and a single photodiode (PD), and outputs a plurality of optical beams used in the exposure of the photosensitive drum 102 from the plurality of LDs. In the present embodiment, the memory 208 functions as a storage unit.

In the present embodiment, the laser chip 203 has four LDs including LD1, LD2, LD3, and LD4, which serve as a plurality of laser light sources. The LD1, LD2, LD3, and LD4 output, as shown in FIG. 3, optical beams 301, 302, 303, and 304, respectively, due to the driving current supplied from a current source (not shown) in the light power control unit 207. Thus, the optical scanning device 101 exposes the surface of the photosensitive drum 102 that is the exposure target with those four optical beams output by the four LDs. In the present embodiment, it is assumed that, among the LD1 to LD4, the LD1 is the LD of which an upper limit value of the driving current that can be supplied is measured in advance (hereinafter referred to as “representative LD”). Note that the LD1 corresponds to the first laser light source, and the LD2 to LD4 correspond to the second laser light source other than the first laser light source. As described later, this upper limit value is used to determine reference data used as a reference for limiting the driving current within an allowable range when APC is performed.

After the image forming apparatus 100 starts image formation, the light power control unit 207 starts to control each component in the optical scanning device 101. The light power control unit 207 causes LD1 to LD4 to emit light by supplying the driving current from a plurality of current sources in the light power control unit 207 to the corresponding LDs (LD1 to LD4) in the laser chip 203. A plurality of optical beams output from the LD1 to LD4 in the laser chip 203 enter the polygon mirror 201. The polygon mirror 201 has a plurality of mirror surfaces, and rotates with a constant angular velocity in the arrow direction shown in FIG. 2 while the rotation of the polygon mirror 201 is driven by the polygon motor 202 that operates based on the control performed by the light power control unit 207. The polygon mirror 201 reflects each optical beam with its rotation in the arrow direction such that each incident optical beam is deflected at a continuous angle.

The optical beam deflected by the polygon mirror 201 enters the f-θ lens 204. The f-θ lens 204 applies the beam-condensing action to the plurality of incident optical beams. The f-θ lens 204 also corrects distortion to ensure the temporal linearity of the plurality of optical beams that pass through the f-θ lens 204 and are reflected by the reflection mirror 206 during a scan on the surface of the photosensitive drum 102. Thus, the plurality of optical beams are combined on the surface of the photosensitive drum 102 and scanned over the surface with a constant velocity in the arrow direction.

Here, the BD (Beam Detect) sensor 205 (light receiving unit) is a sensor for detecting a reflected light from the polygon mirror 201. The BD sensor 205 is arranged at a location at which, among the optical beams reflected by the respective mirror surfaces of the polygon mirror 201, an optical beam on the scan start side is detected. The BD sensor 205, upon detecting an optical beam, outputs a signal (BD signal) that indicates detection of the optical beam to the light power control unit 207. The light power control unit 207 uses an input BD signal as a synchronization signal for synchronizing the rotation of the polygon mirror 201 with the start timing of image writing using an image signal at the laser chip 203.

When APC is performed with respect to each of the LD1 to LD4 in such an optical scanning device 101, data to be a reference for limiting the driving current supplied to each LD within an allowable range is necessary. As mentioned above, this data corresponds to data to be a reference for controlling the driving current at an appropriate range (allowable range) for the purpose of preventing the driving current supplied to the LDs from becoming overcurrent, which breaks the LDs. The reference data is prepared in advance as a limit value of the driving current, for example, as a value of the driving current corresponding to the maximum value (100% light power) in a light power control range.

Such reference data can be obtained by performing measurement in advance at the time of factory shipment using a measurement tool (light power adjustment tool) with respect to each of the LD1 to LD4 incorporated into the optical scanning device 101. However, if such measurement is performed with respect to each of a plurality of LDs in a multi-beam optical scanning device 101, as mentioned above, the man-hour in the apparatus assembly process at the time of factory shipment increases and the entire measurement time also increases, which may result in lower productivity.

Therefore, in the present embodiment, the reference data on the LD1 to LD4 incorporated into the optical scanning device 101 is obtained without performing prior measurement on all of the LD1 to LD4. In other words, the reference data on the LD1 (first laser light source) used as the representative LD is obtained with prior measurement as in the conventional technique. Meanwhile, the reference data on the LD2 to LD4 (second laser light source) other than the LD1 is obtained without the need of prior measurement. That is, as to the LD2 to LD4, a value of the driving current with which the light power of the LD2 to LD4 is adjusted to the light power of the LD1 when being caused to emit light based on the reference data obtained with measurement with respect to the LD1 is obtained as the reference data.

More specifically, the light power of the LD1 when the LD1 is caused to emit light with the driving current corresponding to the reference data on the LD1 is detected to obtain a light power detection value, and further the driving current supplied to each of the LD2 to LD4 is adjusted such that the light power of each of the LD2 to LD4 is equal to the light power detection value of the LD1. With this adjustment, a value of the driving current that is being supplied to each of the LD2 to LD4 when the light power detection value of each of the LD2 to LD4 is equal to the light power detection value of the LD1 is acquired as the reference data on each LD. The specific processing performed in the optical scanning device 101 is described hereafter in more detail.

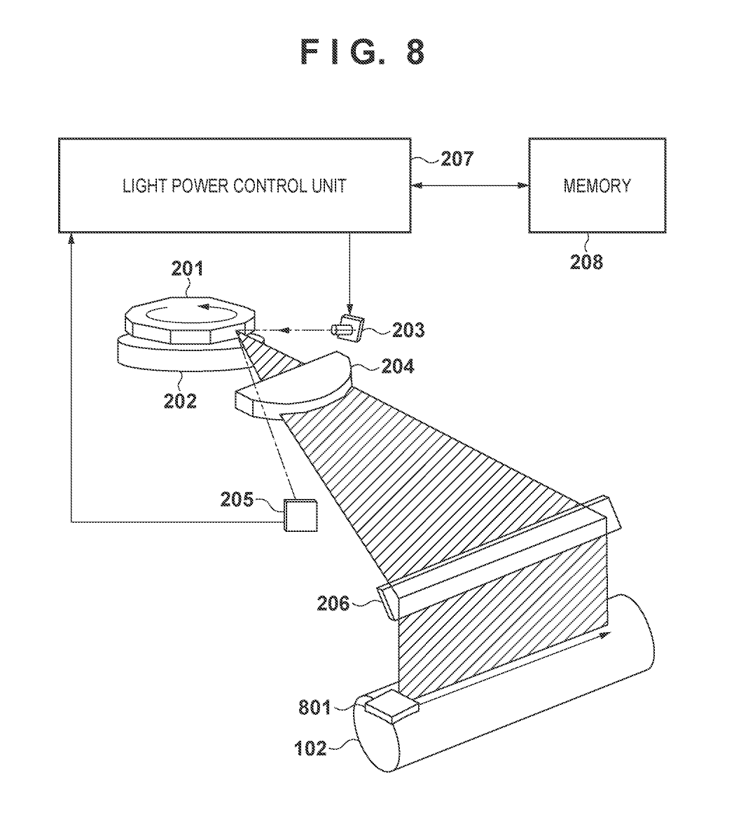

In the following description, the BD sensor 205 is used as a sensor (light receiving unit) for detecting the light power of each LD. However, as shown in FIG. 8, a PD sensor 801 provided near the surface of the photosensitive drum 102 may alternatively be used as a sensor for detecting the light power of each LD. The PD sensor 801 can detect the light power of an optical beam from each LD after being reflected by the reflection mirror 206 that is close to the actual light power on the surface of the photosensitive drum 102. Alternatively, a PD provided inside the laser chip 203 may be used as a sensor (light receiving unit) that detects the light power of each LD. In any case, the same effect of the processing described below can be achieved.

<Block Configuration Associated with Obtaining of Reference Data>

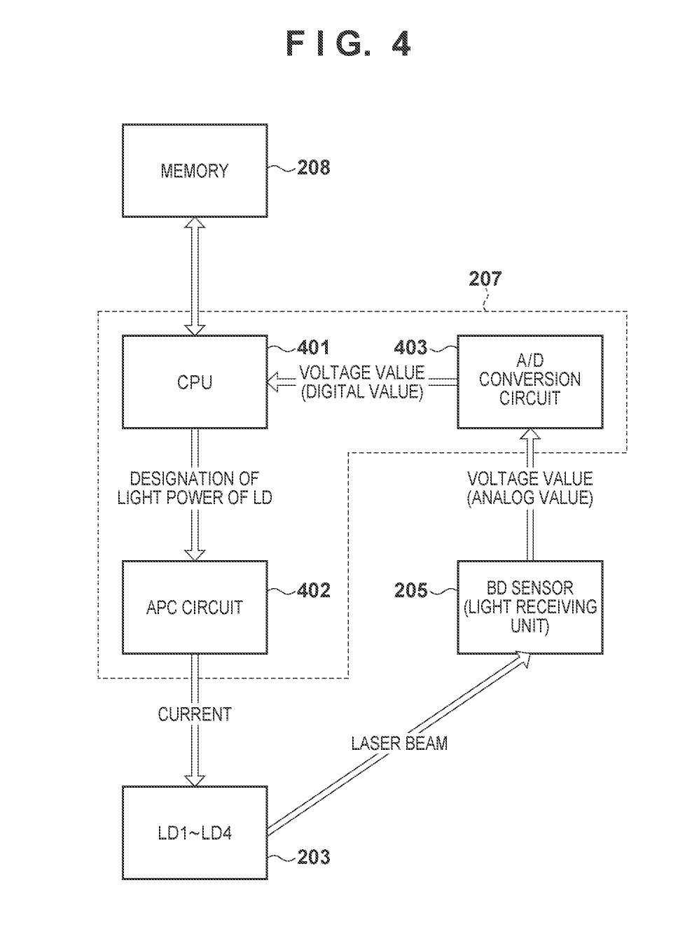

Next, processing for obtaining the reference data corresponding to the LD2 to LD4 (second laser light source) based on the reference data on the LD1 (first laser light source), which is the representative LD, obtained with prior measurement at the time of factory shipment is described with reference to the block diagram of FIG. 4. In this diagram, the processing to be performed using each of the LD1 to LD4 is shown in a single common diagram.

As shown in FIG. 4, the light power control unit 207 includes a CPU 401, an APC circuit 402, and an analog to digital (A/D) conversion circuit 403. The APC circuit 402 is a circuit for controlling the light power with respect to each of the LD1 to LD4 in the laser chip 203 in response to an instruction from the CPU 401, and controls the light power of each LD by controlling the driving current to be supplied to each LD from the current source. In other words, the APC circuit 402 is a circuit for performing APC with respect to the LD1 to LD4. At the time of factory shipment, the APC circuit 402 further controls the light power of each of the LD1 to LD4 in response to an instruction from the CPU 401 to obtain the reference data corresponding to the LD2 to LD4 from the reference data corresponding to the representative LD.

The memory 208 stores in advance the reference data used as a reference when the driving current to be supplied to the representative LD (LD1) is controlled with APC. The reference data corresponding to the representative LD stored in the memory 208 is the data equivalent to a value obtained by reducing the upper limit value of the driving current that can be supplied to the representative LD by a predetermined amount. This value obtained by reducing the upper limit value of the driving current by the predetermined amount is measured in advance at the time of factory shipment using the representative LD1 by a measurement tool (light power adjustment tool). Thus, to secure a certain degree of allowance, the exact upper limit value of the driving current is not set as the maximum value (limit value) of the control range of the driving current of the LD1, but the data equivalent to the value obtained by reducing this upper limit by the predetermined amount corresponding to the degree of allowance may be used as the reference data.

To acquire the reference data corresponding to the LD2 to LD4 other than the representative LD (LD1), the light power control unit 207 determines the driving current supplied to each of the LD2 to LD4 for causing the LD2 to LD4 to emit light with the light power equal to the light power of the LD1 when being caused to emit light based on the corresponding reference data. The light power control unit 207 also stores in the memory 208 a value of the driving current determined for each of the LD2 to LD4 as the reference data used as a reference for limiting the driving current to be supplied to the LD2 to LD4 within an allowable range at the time of APC.

(Obtaining of the Light Power Detection Value of the Representative LD)

Next, the processing performed by the light power control unit 207 is described in more detail with reference to FIG. 4. First, the CPU 401 causes, based on the reference data on the representative LD stored in advance in the memory 208, the representative LD to emit light with the driving current corresponding to the reference data, and obtains the light power of the representative LD as the light power detection value.

The CPU 401 refers to the memory 208 and reads out the reference data corresponding to the representative LD stored in advance in the memory 208. Then, to cause the representative LD to emit light with the light power in accordance with the driving current corresponding to the reference data read out above, the CPU 401 orders the APC circuit 402 to supply the driving current corresponding to this reference data to the representative LD. The APC circuit 402 performs, in response to the order from the CPU 401, control for supplying the driving current of the designated magnitude from the current source to the representative LD (LD1).

With the driving current supplied from the APC circuit 402, among the LD1 to LD4 in the laser chip 203 the representative LD (LD1) emits light. An optical beam output due to light emission by the representative LD enters the BD sensor 205 (light receiving unit). The BD sensor 205 outputs a voltage proportional to the light power of the received optical beam to the A/D conversion circuit 403. The A/D conversion circuit 403 converts the input analog voltage value into a digital value and outputs it to the CPU 401. Thus, the CPU 401 can detect, as a corresponding voltage value, the light power of the optical beam emitted by the representative LD due to the driving current corresponding to the reference data stored in advance in the memory 208. The CPU 401 stores the detected voltage value as the light power detection value of the representative LD in the memory 208.

(Obtaining of the Reference Data on the LD2 to LD4)

Next, the CPU 401 obtains the reference data corresponding to the LD2 to LD4 other than the representative LD based on the obtained light power detection value of the representative LD (LD1). The CPU 401 specifies the driving current with respect to each of the LD2 to LD4 to be used as reference data corresponding to each LD based on the light power detection value of the representative LD by adjusting the driving current supplied from the APC circuit 402 to each LD. Although only the processing for the LD2 is described here, the same processing may be performed also on the LD3 and LD4.

First, the CPU 401 designates an arbitrary initial value of a driving current value (e.g., low driving current value) to the APC circuit 402, and orders the APC circuit 402 to start to supply the driving current to the LD2. The APC circuit 402 performs control for supplying the driving current of the magnitude designated by the CPU 401 from the current source to the LD2. With the driving current supplied from the APC circuit 402, the LD2 in the laser chip 203 emits light with the light power in accordance with the current value of this driving current.

An optical beam output due to light emission by the LD2 enters the BD sensor 205 (light receiving unit). The BD sensor 205, as described above, outputs the voltage proportional to the light power of the received optical beam to the A/D conversion circuit 403. The A/D conversion circuit 403 converts an input analog voltage value into a digital value and outputs it to the CPU 401. Thus, the CPU 401 can detect the light power of the optical beam output by the LD2 as the corresponding voltage value.

The CPU 401 also compares the detected light power detection value (voltage value) of the LD2 with the light power detection value (voltage value) of representative LD already stored in the memory 208, and determines whether or not those values are equal. If, as result of the comparison, those two light powers are not equal, the CPU 401 orders the APC circuit 402 to adjust the driving current supplied from the APC circuit 402 to the LD2 such that the light power of the LD2 is equal to that of the representative LD. For example, if the light power detection value of the LD2 is smaller than the light power detection value of the representative LD, the CPU 401 may order the APC circuit 402 to increase the driving current so as to increase the light power of the LD2.

The CPU 401 repeats the adjustment of the driving current of the LD2 and the comparison of the light power detection value until the light power detection value of the LD2 becomes equal to the light power detection value of the representative LD. Eventually, when the two light powers become equal, the CPU 401 specifies a value of the driving current that is being supplied from the APC circuit 402 to the LD2 as a determined driving current value corresponding to the reference data on the LD2. The CPU 401 stores the specified driving current value as the reference data on the LD2 in the memory 208. After that, the CPU 401 also performs, with respect to the LD3 and LD4, the above-described processing for the LD2, thereby obtaining the reference data on the LD3 and LD4 and similarly storing the reference data in the memory 208.

<Flowchart Associated with Processing for Obtaining Reference Data>

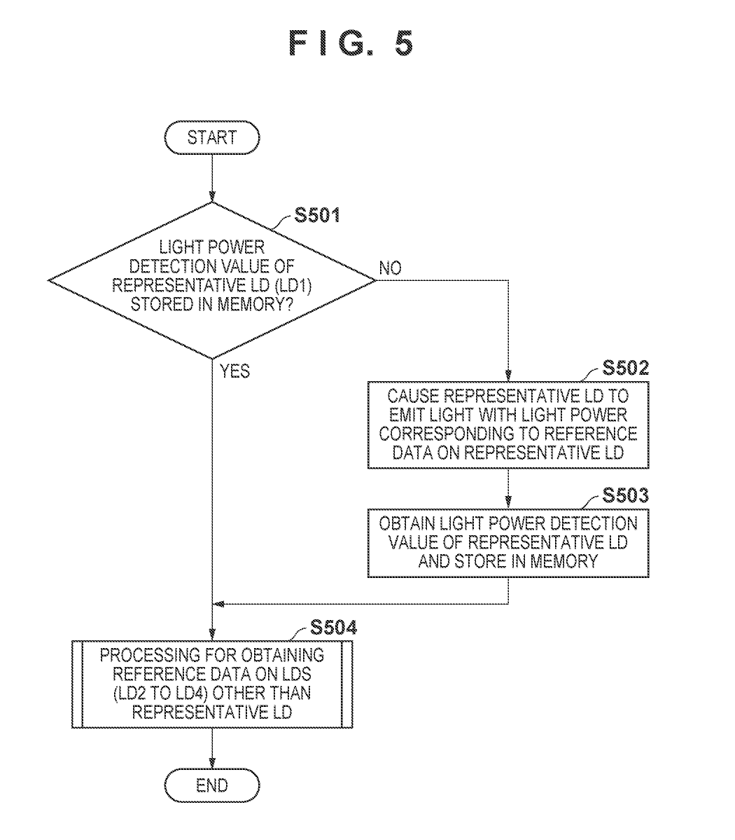

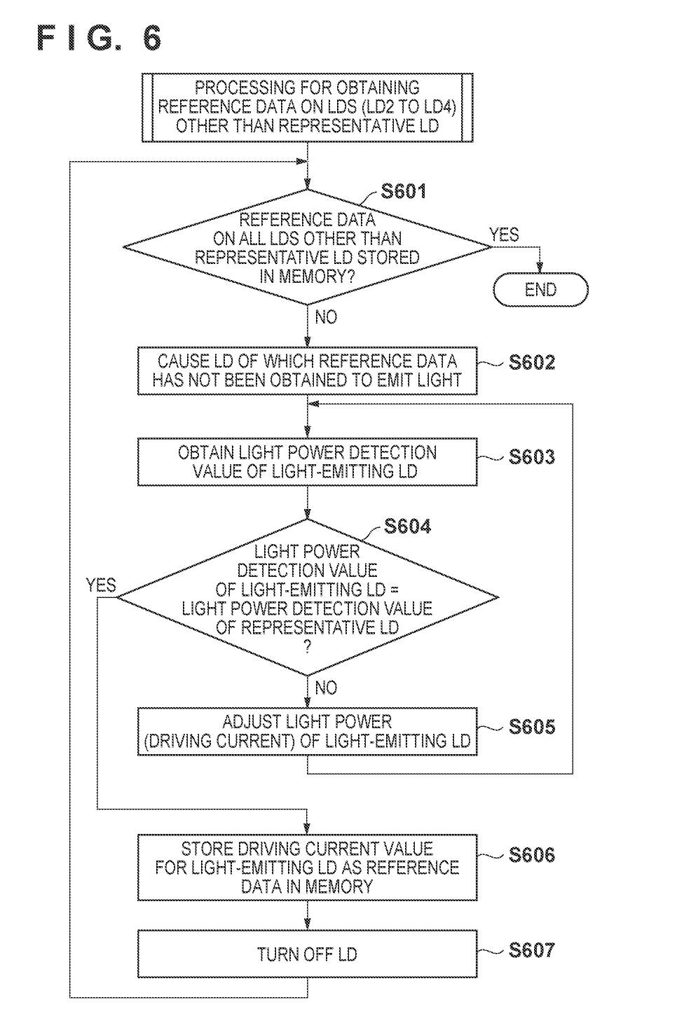

Next, the flow of processing described above referring to FIG. 4 for obtaining the reference data corresponding to the LD2 to LD4 (second laser light source) performed at the time of factory shipment is described with reference to the flowcharts of FIGS. 5 and 6. The process at each step shown in FIGS. 5 and 6 is implemented by the CPU 401 reading out control programs stored in advance in the memory 208 or the like into a RAM (not shown) and executing those programs. As described above, it is assumed that the reference data corresponding to the representative LD (LD1) obtained with prior measurement with respect to the representative LD is stored in advance in the memory 208.

First, at S501, the CPU 401 determines whether or not the light power detection value of the representative LD is already stored in the memory 208. Here, if the CPU 401 determines that the light power detection value is stored in the memory 208, it advances the processing to S504, and if not, it advances the processing to S502.

At S502, the CPU 401 refers to the reference data on the representative LD stored in advance in the memory 208, and causes the representative LD to emit light with the light power in accordance with the reference data by supplying the driving current corresponding to the reference data to the representative LD. Then, at S503, the CPU 401 obtains the light power detection value output from the BD sensor 205 (light receiving unit) due to receipt at the light receiving unit of the optical beam of the representative LD caused to emit light. At this time, the CPU 401 stores the obtained light power detection value in the memory 208. After that, the CPU 401 advances the processing to S504.

At S504, the CPU 401 performs processing for obtaining the reference data corresponding to the LD2 to LD4 other than the representative LD and storing the reference data in the memory 208. More specifically, it performs the processing in accordance with the flowchart shown in FIG. 6 described below.

At S601, the CPU 401 determines whether or not the reference data on all LDs (LD2 to LD4) other than the representative LD is already stored in the memory 208. Here, if the CPU 401 determines that the reference data on all LDs is stored in the memory 208, it ends the processing, and if the CPU 401 determines that it is not stored, it advances the processing to S602. At S602, the CPU 401 causes an LD (any of the LD2 to LD4) of which the reference data has not been obtained to emit light. Here, for example, the CPU 401 may cause the LD of which the reference data has not been obtained to emit light in the order of the LD2 to LD4 by supplying thereto the driving current corresponding to a predetermined initial value. The predetermined initial value is a driving current value obtained at the time of designing with which the LDs are not damaged.

Next, at S603, the CPU 401 obtains the light power detection value output by the BD sensor 205 (light receiving unit) due to receipt by the light receiving unit of the optical beam of the LD caused to emit light. Further, at S604, the CPU 401 determines whether or not the light power detection value (obtained at S603) of the LD caused to emit light is equal to the light power detection value of the representative LD (obtained at S503 and stored in the memory 208). Here, if the CPU 401 determines that those light power detection values are not equal, it advances the processing to S605.

At S605, the CPU 401 adjusts the driving current supplied to the LD caused to emit light to the driving current of a different current value, thereby adjusting the light power of this LD. After that, the CPU 401 performs the process at S603 and S604 again. At S604, if it is determined that the light power detection value of the LD caused to emit light is equal to the light power detection value of the representative LD, the processing is advanced to S606. Thus, the process at S603 to S605 is repeated until the light power of the LD caused to emit light becomes equal to the light power of the representative LD (based on the reference data).

At S606, the CPU 401 stores in the memory 208 the current value of the driving current that is being supplied to the LD caused to emit light at that point in time as the reference data on this LD. Further, at S607, the CPU 401 turns off the LD for which obtaining of the reference data is finished, and returns the processing to S601. At S601, the CPU 401 determines again whether or not the reference data on all LDs other than the representative LD is stored in the memory 208 to perform processing for obtaining the reference data for the LDs of which the reference data has not been acquired. Further, if processing for obtaining the reference data on all LDs is finished (“YES” at S601), the CPU 401 terminates the entire session of processing.

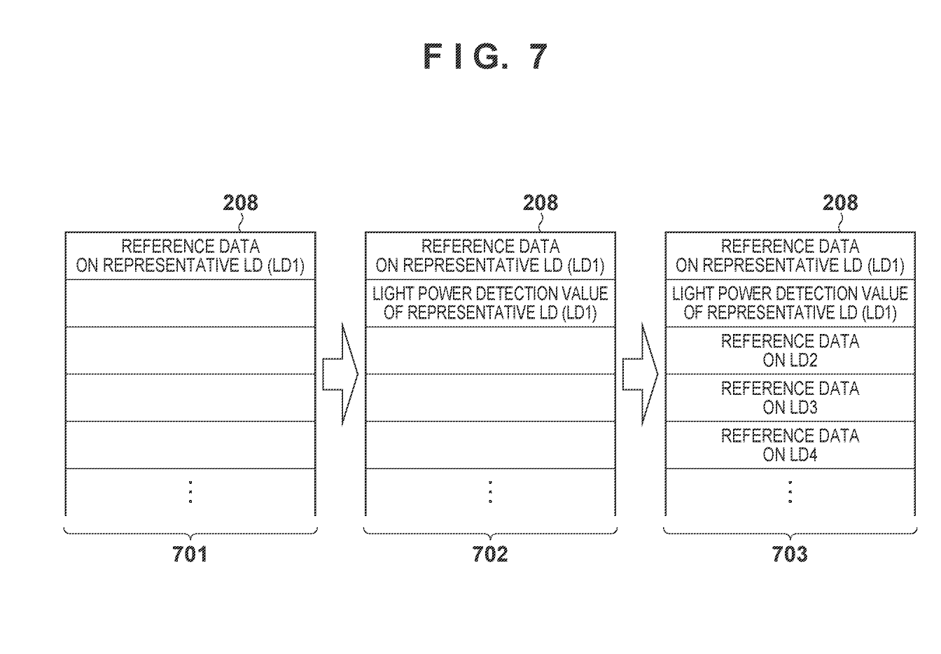

Here, variation in data in the memory 208 during the obtaining of the reference data according to the flowcharts shown in FIGS. 5 and 6 is described with reference to FIG. 7. At the start of the processing, the reference data measured with respect to the representative LD at the time of factory shipment using a light power adjustment tool is already stored in the memory 208 as represented by reference numeral 701. Next, after the light power detection value on the representative LD is obtained at S503, it is additionally stored in the memory 208 as represented by reference numeral 702. Further, after the reference data on the LD2 to LD4 other than the representative LD is obtained, it is sequentially stored in the memory 208 at S606. Eventually, as represented by reference numeral 703, the memory 208 stores the reference data on the representative LD (LD1), as well as the reference data on the LD2 to LD4 obtained based on the reference data on the representative LD.

<Use of the Reference Data in APC>

In the optical scanning device 101, the reference data obtained in advance with respect to the representative LD (LD1 corresponding to the first laser light source) and the reference data obtained with respect to each of the LDs other than the representative LD (LD2 to LD4 corresponding to the second laser light source) are used when APC is performed. The reference data corresponding to each of the LD1 to LD4 is used as data that indicates the limit value of the driving current when the APC circuit 402 provides the driving current to each LD. More specifically, when performing APC with respect to the LDs using the circuit 402, the CPU 401 may control driving current supplied to each LD such that the driving current does not exceed the limit value indicated by the reference value corresponding to the LD stored in the memory 208, thereby controlling the light power of each LD at a predetermined target light power. Further, when controlling the driving current supplied to each LD to achieve the predetermined target light power, the CPU 401 may also designate the driving current to the APC circuit 402 using a relative proportion (0 to 100%) to the maximum value (100% light power) which is the limit value indicated by the reference data.

As described above, in the present embodiment, when APC is performed with respect to the first laser light source (LD1) in an exposure apparatus having a plurality of LDs, the reference data used as a reference for limiting the driving current to be supplied to the LD1 within an allowable range is stored in advance in the memory 208. Meanwhile, the reference data on the second laser light source (LD2 to LD4) other than the LD1 is obtained based on the reference data on the LD1 stored in the memory 208. The exposure apparatus determines, as the driving current supplied to each of the LD2 to LD4, the driving current with which the light power of each of the LD2 to LD4 is equal to that of the LD1 caused to emit light based on the reference data on the LD1 stored in the memory 208. Further, the driving current determined for each of the LD2 to LD4 is stored as the reference data in the memory 208.

Thus, in a multi-beam exposure apparatus, the reference data on the first laser light source is obtained with prior measurement, while the reference data on other laser light sources can be easily obtained without the need of prior measurement. As a result, it is possible at the time of factory shipment to prevent the man-hour in the apparatus assembly process from increasing in connection with adoption of the multi-beam system.

According to the present embodiment, the reference data on the first laser light source needs to be obtained with prior measurement at the time of factory shipment. However, the time when the reference data on other laser light sources is acquired is not limited to the time of factory shipment. That is, if the reference data on the first laser light source is stored in the memory 208 at the time of factory shipment, the processing illustrated in FIGS. 5 and 6 can be performed at any time after shipment of the apparatus, and as a result, the reference data on the laser light sources other than the first laser light source can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-137738, filed Jun. 21, 2011, which is hereby incorporated by reference herein in its entirety.

What is claimed is:

1. An exposure apparatus having a plurality of laser light sources for outputting an optical beam due to a drive current supplied from a current source, comprising:
a storage unit configured to store reference data used for limiting a driving current to be supplied to a first laser light source among the plurality of laser light sources within an allowable range when a light power of the first laser light source is controlled at a predetermined light power by controlling the driving current;
a determination unit configured to determine a driving current supplied to a second laser light source other than the first laser light source among the plurality of laser light sources such that the light power of the second laser light source is equal to the light power of the first laser light source when being caused to emit light based on the reference data stored in the storage unit; and
a storing unit configured to store, in the storage unit, a value of the driving current determined by the determination unit as the reference data used when the driving current supplied to the second laser light source is controlled.

2. The exposure apparatus according to claim 1, wherein the determination unit comprises:
a unit configured to cause the first laser light source to emit light by supplying the driving current corresponding to the reference data stored in the storage unit to the first laser light source;
a unit configured to detect the light power of an optical beam emitted by the first laser light source due to the driving current corresponding to the reference data stored in the storage unit;
a unit configured to supply the driving current to the second laser light source and adjust the driving current supplied to the second laser light source such that the light power of an optical beam emitted by the second laser light source is equal to the light power detected with respect to the first laser light source; and
a unit configured to specify, as a determined driving current value, the driving current that is being supplied to the second laser light source when the light power of the optical beam emitted by the second laser light source becomes equal to the light power detected with respect to the first laser light source.

3. The exposure apparatus according to claim 1, wherein the reference data corresponding to the first laser light source stored in the storage unit is data equivalent to a value obtained by reducing, by a predetermined amount, an upper limit value of the driving current that can be supplied to the first laser light source, the upper limit value being measured in advance using the first laser light source.

4. The exposure apparatus according to claim 1, further comprising a light power control unit configured to control, with respect to each of the plurality of laser light sources, the light power of the laser light source at the predetermined light power when an exposure target is exposed with a plurality of optical beams, by controlling the driving current supplied to the laser light source using the reference data corresponding to the laser light source stored in the storage unit.

5. The exposure apparatus according to claim 4, wherein the reference data corresponding to each of the plurality of laser light sources is data indicating a limit value of the driving current when being supplied to the light source, and
the light power control unit controls, with respect to each of the plurality of laser light sources, the light power of the laser light source at the predetermined light power by controlling the driving current supplied to the laser light source within a range not exceeding the limit value indicated by the reference data corresponding to the laser light source stored in the storage unit.

6. The exposure apparatus according to claim 5, wherein the light power control unit controls, with respect to each of the plurality of laser light sources, the light power of the laser light source at the predetermined light power by specifying the driving current using a relative proportion to a maximum value which is the limit value indicated by the reference data corresponding to the laser light source stored in the storage unit and controlling the driving current supplied to the laser light source.

7. An image forming apparatus having an image carrier, comprising:
a charge unit configured to charge a surface of the image carrier;
the exposure apparatus according to claim 1 configured to expose the surface of the image carrier by scanning, over the surface of the image carrier, a plurality of optical beams corresponding to image information output by the plurality of laser light sources due to the driving current corresponding to the image information supplied from a current source to the plurality of laser light sources; and
a developing unit configured to develop an electrostatic latent image corresponding to the image information formed on the surface of the image carrier due to the exposure by the exposure apparatus and form an image to be transferred to a recording material on the surface of the image carrier.

8. An adjustment method for an exposure apparatus including a plurality of laser light sources each outputting an optical beam due to a driving current supplied from a current source, and a storage unit that configured to store reference data used for limiting a driving current to be supplied to a first laser light source among the plurality of laser light sources within an allowable range when a light power of the first laser light source is controlled at a predetermined light power by controlling the driving current, the adjustment method comprising:
determining a driving current supplied to a second laser light source other than the first laser light source among the plurality of laser light sources such that the light power of the second laser light source is equal to the light power of the first laser light source when being caused to emit light based on the reference data stored in the storage unit; and
storing, in the storage unit, a value of the driving current determined in the determining as the reference data used when the driving current supplied to the second laser light source is controlled.

9. The adjustment method according to claim 8, wherein the determining further comprises:
causing the first laser light source to emit light by supplying the driving current corresponding to the reference data stored in the storage unit to the first laser light source;
detecting the light power of an optical beam emitted by the first laser light source due to the driving current corresponding to the reference data stored in the storage unit;
supplying the driving current to the second laser light source and adjusting the driving current supplied to the second laser light source such that the light power of an optical beam emitted by the second laser light source is equal to the light power detected with respect to the first laser light source; and
specifying, as a determined driving current value, the driving current that is being supplied to the second laser light source when the light power of the optical beam emitted by the second laser light source becomes equal to the light power detected with respect to the first laser light source.
